(19) United States
(12) Patent Application Publication
(10) Pub. No.: US 2014/0143333 A1
(43) Pub. Date: May 22, 2014

(54) SYSTEMS AND METHODS FOR A SOCIAL DISCOVERY PLATFORM

(71) Applicant: Derek Harper Dodge, Hampton, NH (US)

(72) Inventor: Derek Harper Dodge, Hampton, NH (US)

(21) Appl. No.: 13/826,885

(22) Filed: Mar. 14, 2013

Related U.S. Application Data
(60) Provisional application No. 61/728,111, filed on Nov. 19, 2012.

(51) Int. Cl. H04L 29/08

(52) U.S. Cl. CPC H04L 67/22
USPC 709/204

(57) ABSTRACT

The present solution provides a new social media platform, referred to as a social discovery application, to discover and share with like minded people, such as people in a user's natural communities. The social discovery application allows a user to express their interests and to find people that have the same interests and think like them. For example, the social discovery application may help a user find people most like them at their school, new job, or a new city. The social discovery application includes lots of fun and easy to play games where users express themselves, their interests, and their preferences. The social discovery application then compares their choices to other users' choices in a fun and visual way, and connects users with new potential friends. The social discovery application provides a user a rank order list of people most like them.

### RELATED APPLICATION

This application claims the benefit of and priority to U.S. Provisional Application No. 61/728,111, entitled “Systems and Methods For A Social Discovery Application” and filed on Nov. 19, 2012, which is incorporated herein by reference in its entirety for all purposes.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### FIELD OF THE DISCLOSURE

This disclosure generally relates to systems and methods for providing a social discovery platform to find like mind people based on relative level of likeness between people.

### BACKGROUND OF THE DISCLOSURE

Even with the ubiquity of social networking sites such as Facebook and Linkedln, it is still difficult to find new people not yet known to you that have a similar personality or like the same things. Social networking sites like Facebook may help you reconnect with people you already know, but do not help you find new and interesting people that share your interests. For example, it may be difficult to find like minded people when you first go to college, start a new job, or move to a new state.

### BRIEF SUMMARY OF THE DISCLOSURE

The present solution provides a new social media platform, referred to as a social discovery application, to discover and share with like minded people, such as people in a user's natural communities. The social discovery application allows a user to express their interests and to find people that have the same interests and think like them. For example, the social discovery application may help a user find people most like them at their school, new job, or a new city. The social discovery application includes lots of fun and easy to play games where users express themselves, their interests, and their preferences. The social discovery application then compares their choices to other users choices in a fun and visual way, and connects users with new potential friends. The social discovery application provides a user a rank order list of people most like them. For example, Bob is 94% like them, Jill is 91% like them, and Rick is 88% like them. The people on the list, and the order, could change everyday as more people join and use the social discovery application and people play more games that express their interests. The likeness engine of the social discovery application uses game play results, lists, and surveys to continuously evaluate who is most like other users.

In some aspects, the present solution is directed to a system and method for generating an interest graph for a user based on game play. A social discovery application executing on a device, providing a plurality of games to a plurality of users. Each game of the plurality of games configured to receive a response from a user indicating a preference between two or more items during game play. The social discovery application receives responses from user from playing the plurality of games and generates an interest graph for the user based on responses received from the user from playing the one or more games.

In some embodiments, the social discovery application provides a personality test to the user and generates the interest graph for the user based on results of the personality test and the responses received from the user from playing the one or more games. In some embodiments, the social discovery application provides a list of categories for the user to select one or more categories of interest and generates the interest graph for the user based on the user's selection of one or more categories of interest and the responses received from the user from playing the one or more games.

In some embodiments, the social discovery application determines a degree of likeness between the user and a plurality of users of the social discovery application based on the interest graph of the user and the plurality of user's interest graphs. In some embodiments, the social discovery application provides a comparison between the user and a second user based on one of similarities or differences between their respective interest graphs. In some embodiments, the social discovery application provides as a game for the plurality of games content generated by the user for the game, the content comprising the two or more items for which users indicate their preference via responses during game play. In some embodiments, the social discovery application, receives a request to run a campaign to one or more users of the plurality of users of the social discovery application based on the plurality of user's interest graphs. The campaign may comprise delivering a user generated game to the one or more users. The social discovery application may select, responsive to the request, a first user of the plurality of users to target the campaign based on the first user's interest graph matching one or more criteria for the campaign.

In some aspects, the interest graph of the present solution is used for identifying a degree of likeness between users based on game play. A social discovery application executing on a device, stores to an interest graph of each of a plurality of users responses received during game play from each user from playing one or more games provided by the social discovery application. The one or more games configured to receive a response from a user indicating a preference between two or more items during game play. The social discovery application may generate the interest graph for each user based on responses from playing the plurality of games and results of a personality test provided by the social discovery application. The social discovery application determines a degree of likeness between each user and each of the other users of the plurality of users based on each user's interest graph and provides, by the social discovery application responsive to the determination, an enumerated list of each of the other users ranked by the degree of likeness to the user.

In some embodiments, the social discovery application stores to the interest graph of each user results of a personality test taken by each user and provided by the social discovery application and determines the degree of likeness between each user and each of the others based on each user's interest graph comprising responses from game play and results of the personality test. In some embodiments, the social discovery application stores for each user a selection of categories of interest and determines the degree of likeness between each user and each of the others based on each user's interest graph comprising the responses from game play and the selection of categories of interest. In some embodiments, the social discovery application generates and provides a comparison between the user and a second user comprising one of similarities or differences between the user's interest graph and the second user's interest graph.

In some aspects, the present solution is directed to systems and methods for discovering via the social discovery application other users who are most like them based on any combination of a personality test, category of interest selection/subscription and game play. In some aspects, the present solution is directed to systems and methods for determining a level or ranking of likeness between people based on the combination of a personality test, category of interest selection and subscription and game play. In some aspects, the present solution is directed to systems and methods for users to generate content for the social discovery application, such as photos, lists and games, that feed into and effect the level or ranking of likeness between people. In some aspects the present solution is directed to systems and methods for providing analytics on the data and information about a user's personality, interests and likes based on a personality test, category of interest selection and subscription and game play. In some aspects, the present solution is directed to systems and methods for configuring and executing any type and form of campaign, such as an advertisement campaign or social media ads via the social discovery platform, or other advertising network, which may be targeted to users based on the data tracked via the social discovery platform.

In some aspects, the present solution is directed to a method for identifying a degree of likeness between users based on game play. The method includes storing, by a social discovery application, for each of a plurality of users responses received during game play from the plurality of users playing one or more games provided by the social discovery application. The one or more games are configured to receive a response from a user indicating a preference between two or more items during game play. The method further includes determining, by the social discovery application, a degree of likeness between each user and each of the other users of the plurality of users based on the responses from game play and providing, responsive to identifying a user, an enumerated list of each of the other users ranked by the degree of likeness to the user.

In some embodiments, the method includes storing, by the social discovery application, for each user results of a personality test provided by the social discovery application. The method may also include determining, by the social discovery application, the degree of likeness between each user and each of the others based on the responses from game play and results of the personality test. In some embodiments, the method includes storing, by the social discovery application, for each user a selection of categories of interest. The method may also include determining, by the social discovery application, the degree of likeness between each user and each of the others based on the responses from game play and the selection of categories of interest.

In some embodiments, the method includes providing, by the social discovery application, a comparison between the user and a second user. The comparison may include or identify similarities and/or differences between responses from game play. The comparison may include or identify one of similarities and/or differences between results of a personality test provided by the social discovery application.

In some embodiments, the method includes receiving, by the social discovery application, as a game for the one or more games content generated by the user for the game. The user generated content may include the two or more items for which users indicate their preference via responses during game play.

In some embodiments, the method includes providing by the social discovery application, for each of the other users in the enumerated list the degree of likeness as a percentage identifying how much each of the other users is like the user. In some embodiments, the method includes receiving a selection, by the user, from the enumerated list a second user to discover items of likeness in the degree of likeness and the social discovery application, responsive to the selection, providing details on the degree of likeness between the user and the second user.

In some aspects, the present solution is directed to a system for identifying a degree of likeness between users based on game play. The system includes a social discovery application executable on a server. The social discovery application is configured to provide one or more games, the one or more games configured to receive a response from a user indicating a preference between two or more items during game play. The system includes a storage configured to store for each of a plurality of users responses received during game play from the plurality of users playing one or more games provided by the social discovery application. The system also includes a likeness engine configured to determine degree of likeness between each user and each of the other users of the plurality of users based on the responses from game play. The social discovery application is further configured to provide, responsive to identifying a user, an enumerated list of each of the other users ranked by the degree of likeness to the user.

In some embodiments, the social discovery application is configured to store for each user results of a personality test provided by the social discovery application. The likeness engine may be further configured to determine the degree of likeness between each user and each of the others based on the responses from game play and results of the personality test. In some embodiments, the social discovery application is configured to store to storage a selection of categories of interest for each user. The likeness engine may be further configured to determine the degree of likeness between each user and each of the others based on the responses from game play and the selection of categories of interest.

In some embodiments, the likeness engine is configured to provide a comparison between the user and a second user comprising similarities and/or differences between responses from game play. In some embodiments, the likeness engine is configured to provide a comparison between the user and a second user comprising similarities and/or differences between results of a personality test provided by the social discovery application.

In some embodiments, the social discovery application is configured to receive as a game for the one or more games content generated by the user for the game. The user generated game content may include the two or more items for which users indicate their preference via responses during game play. In some embodiments, the social discovery application is configured to provide for each of the other users in the enumerated list the degree of likeness as a percentage identifying how much each of the other users is like the user. In some embodiments, the social discovery application is configured to receive a selection, by the user, from the enumerated list a second user to discover items of likeness in the degree of likeness. The social discovery application may be further configured to provide, responsive to the selection, details on the degree of likeness between the user and the second user.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2A is a block diagram of an embodiment of a system for providing a social discovery platform;

FIGS. 2B-2V are diagrams of embodiments of various user interfaces and corresponding functionality of the social discovery platform; and

FIG. 3 is a flow diagram depicting an embodiment of a method of using the social discovery platform.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for providing a social discovery platform.

### A. Computing and Network Environment

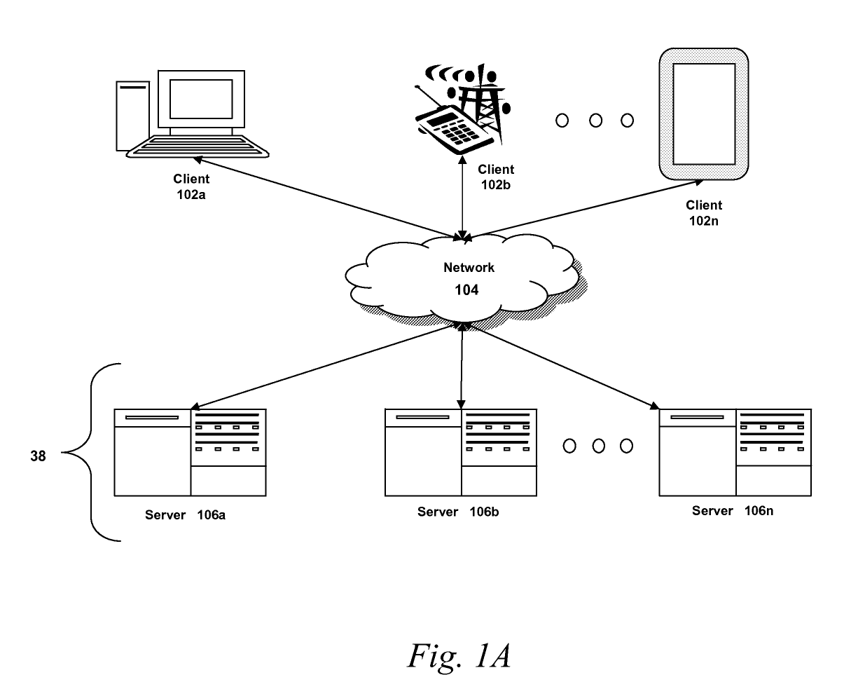

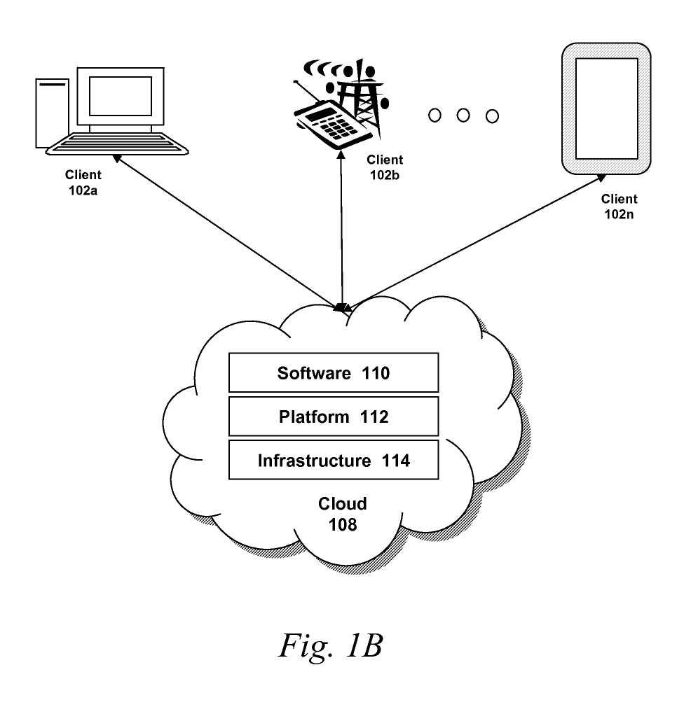

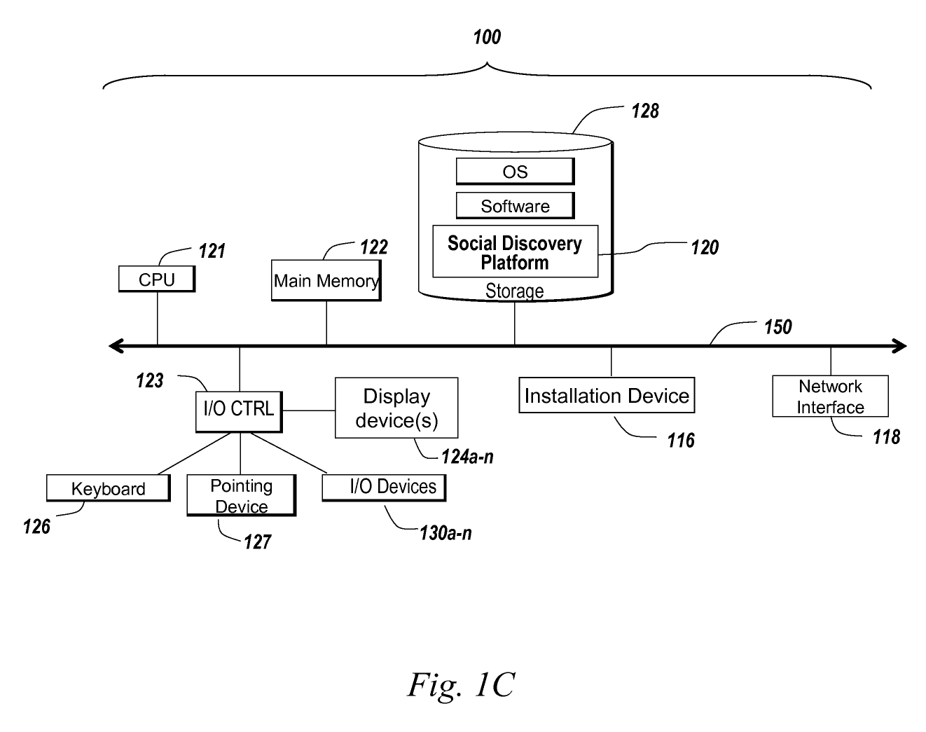

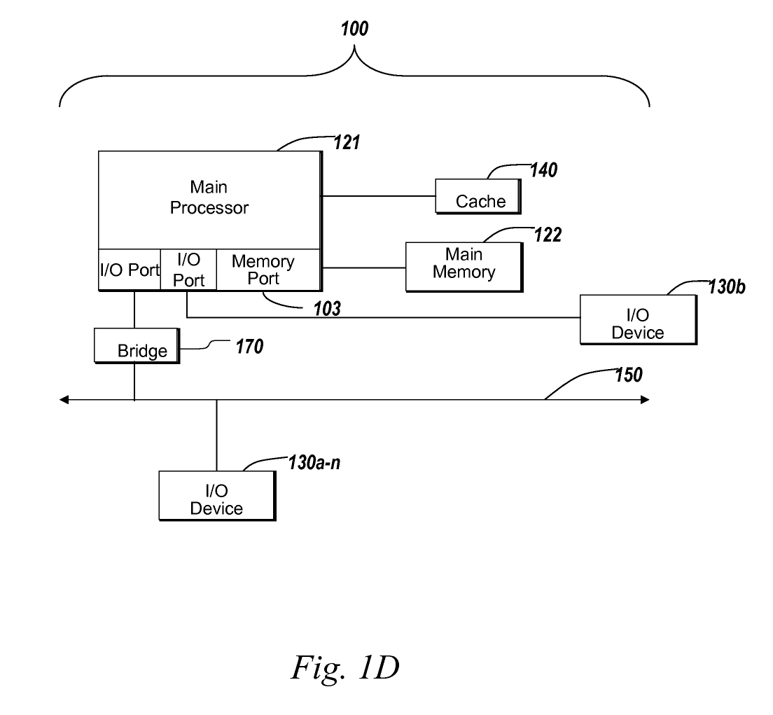

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (Imax), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of the social discovery platform 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g., those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, New York; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the social discovery platform. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, New York.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Social Discovery Platform

Systems and method of the present solution are directed to a social discovery platform to discover and share with like minded people, such as people in a user's natural communities. The social discovery application allows a user to express their interests and to find people that have the same interests and think like them. The social discovery application includes lots of fun easy to play games where users express themselves, their interests, and their preferences. The social discovery application then compares their choices to other users choices in a fun and visual way, and connects users with new potential friends. The social discovery applications provide a user a rank order list of people most like them. The likeness engine of the social discovery application uses game play results, lists, and surveys to continuously evaluate who is most like other users.

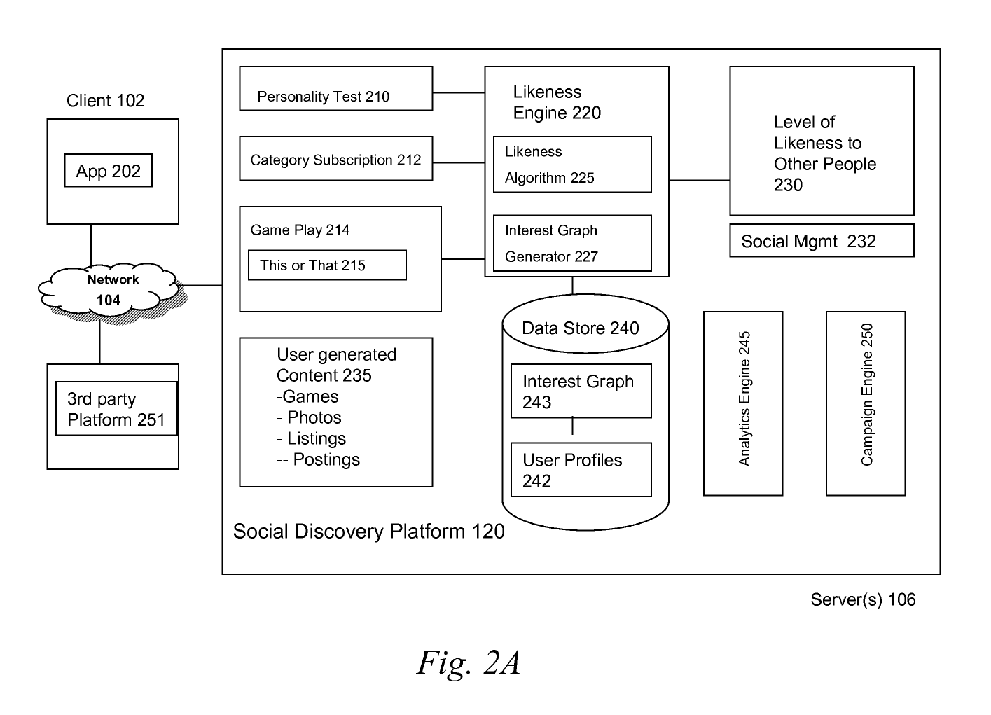

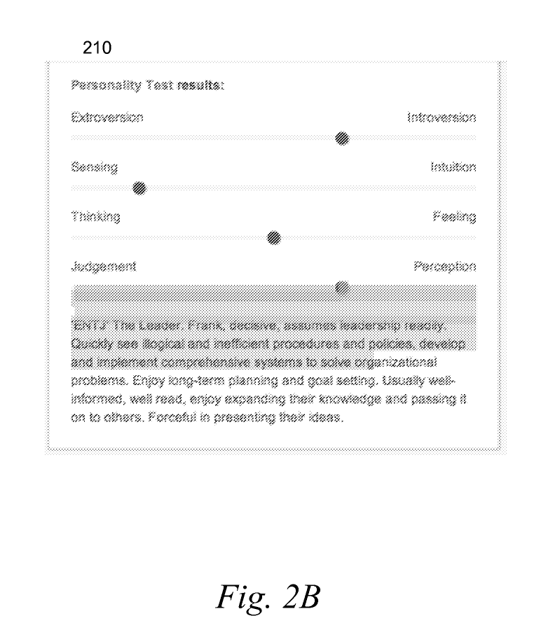

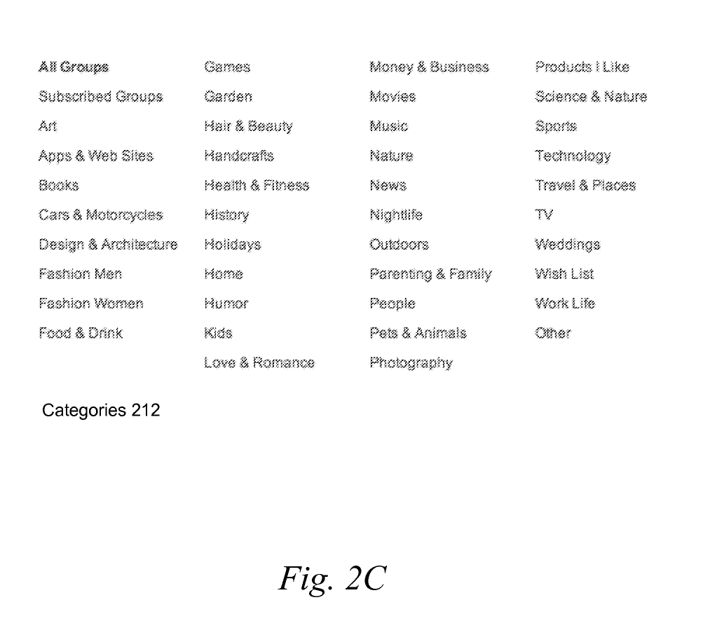

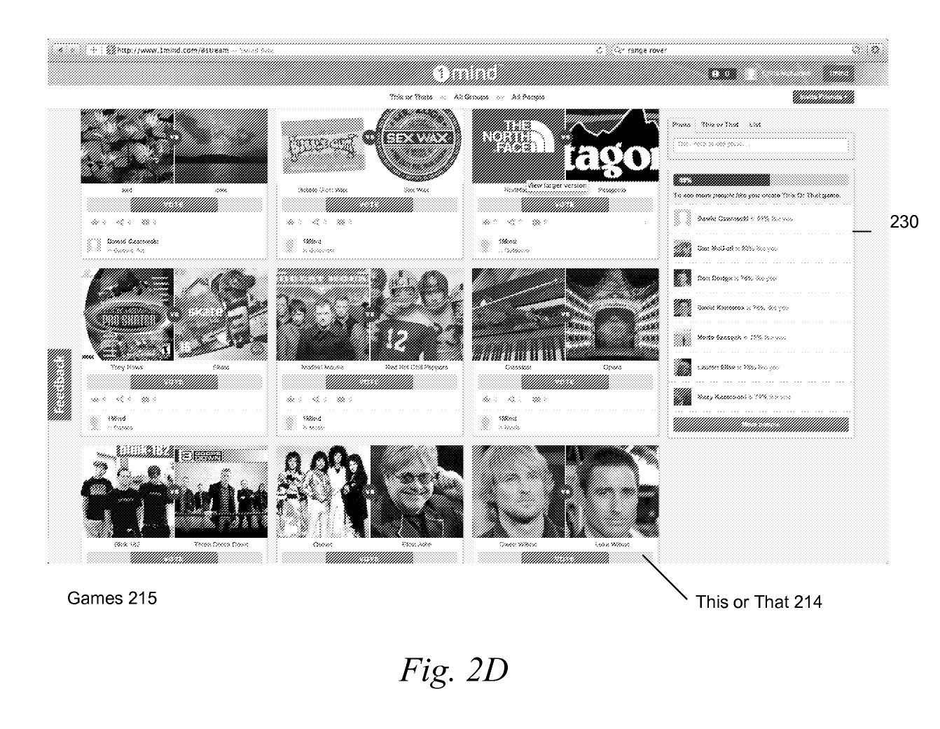

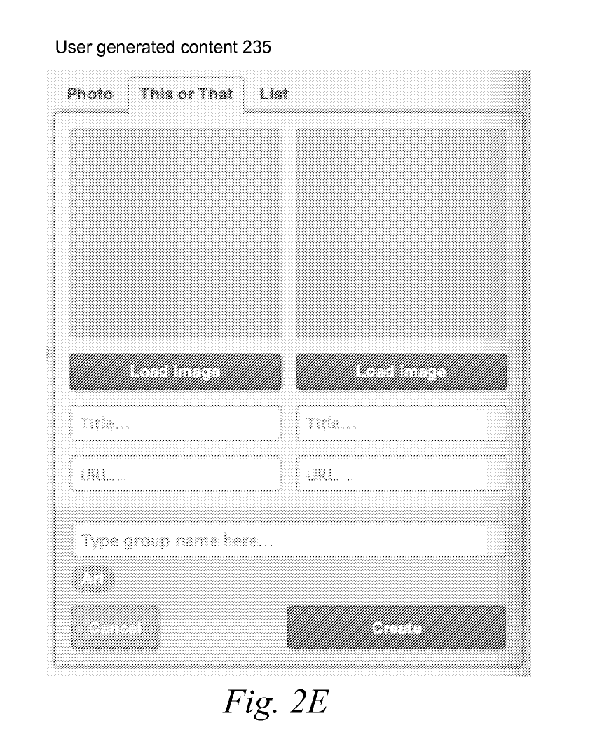

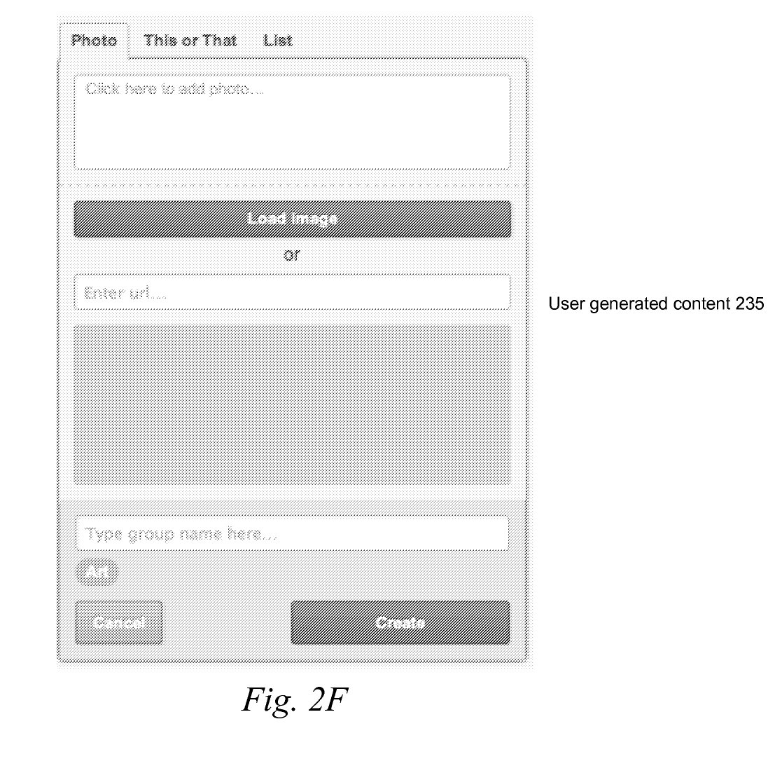

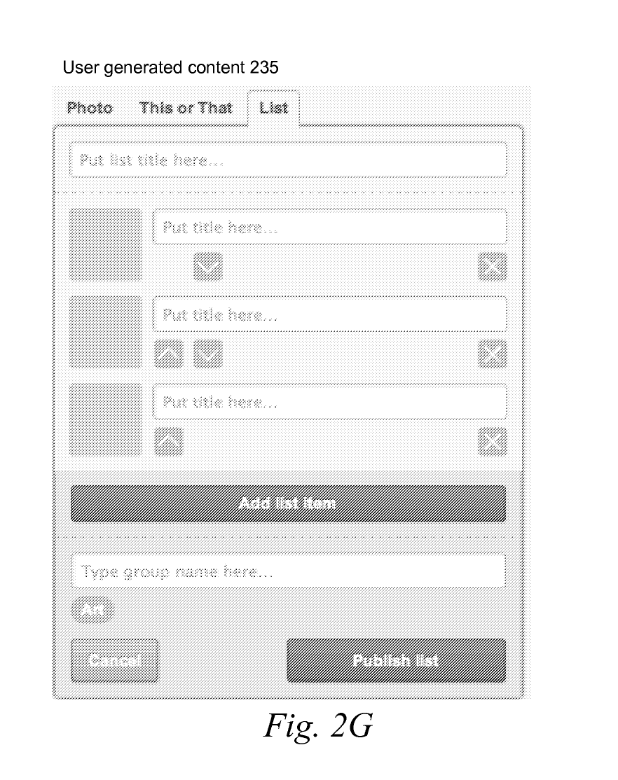

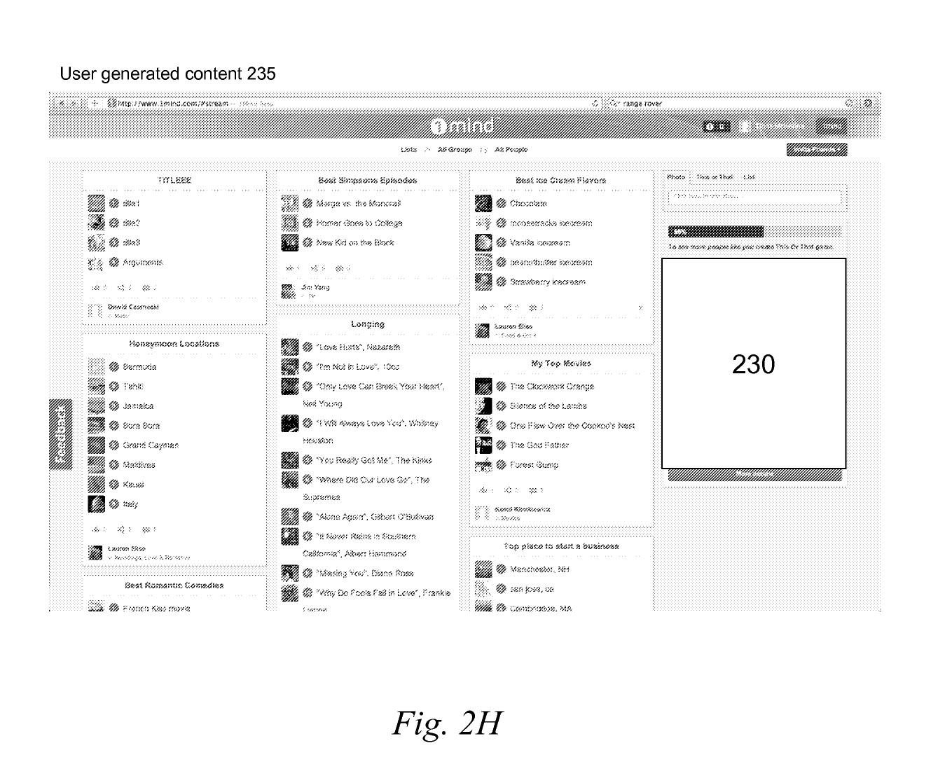

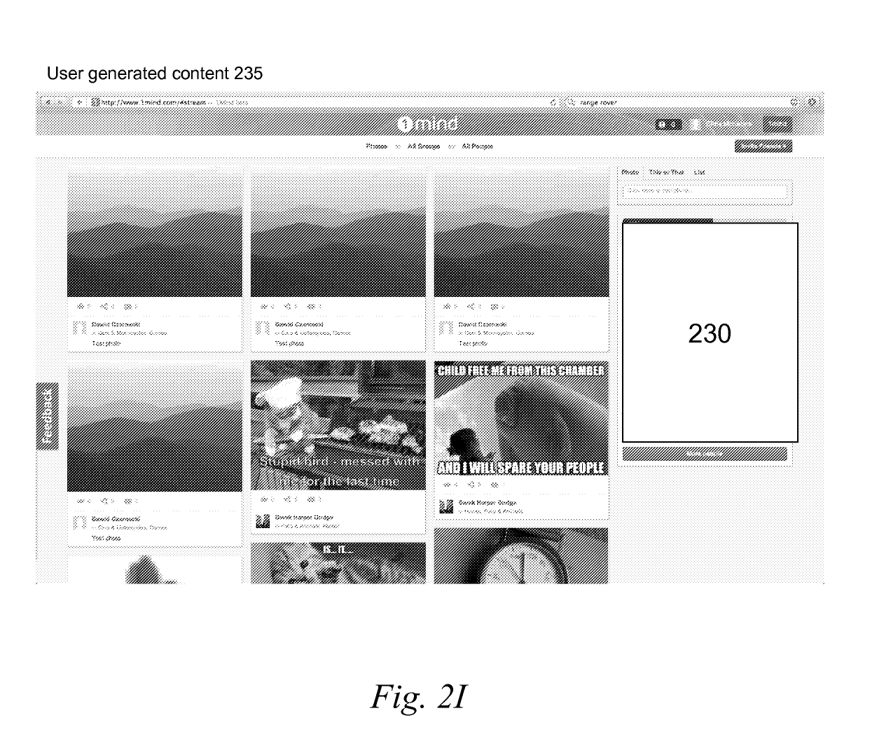

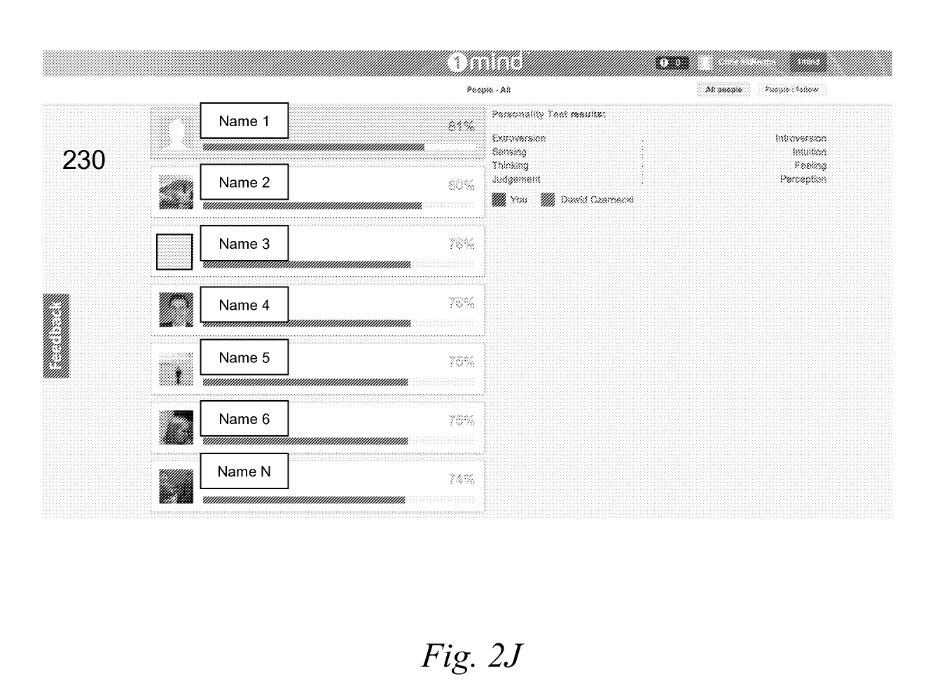

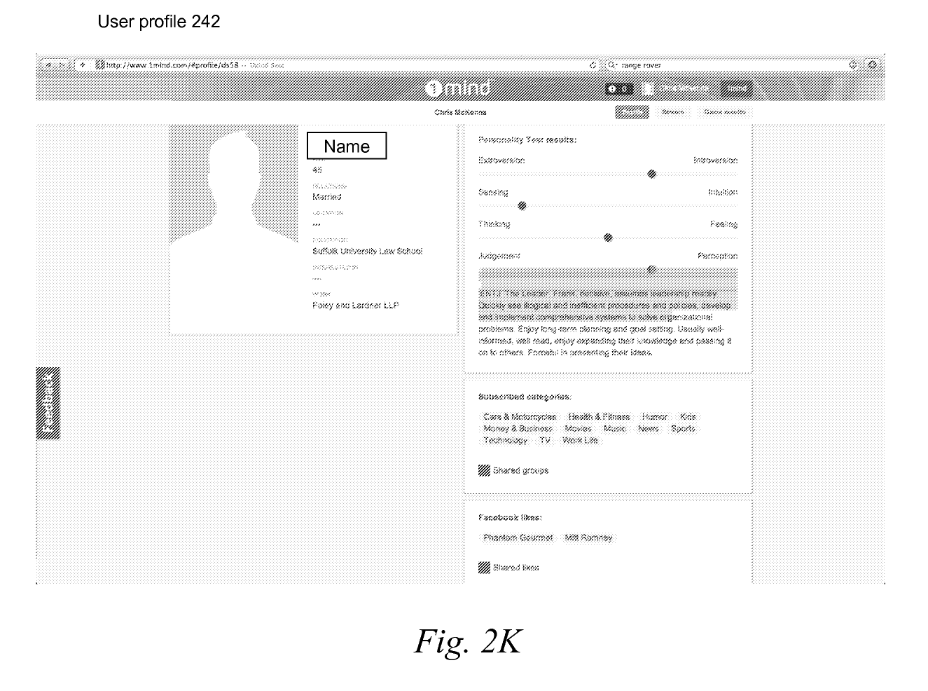

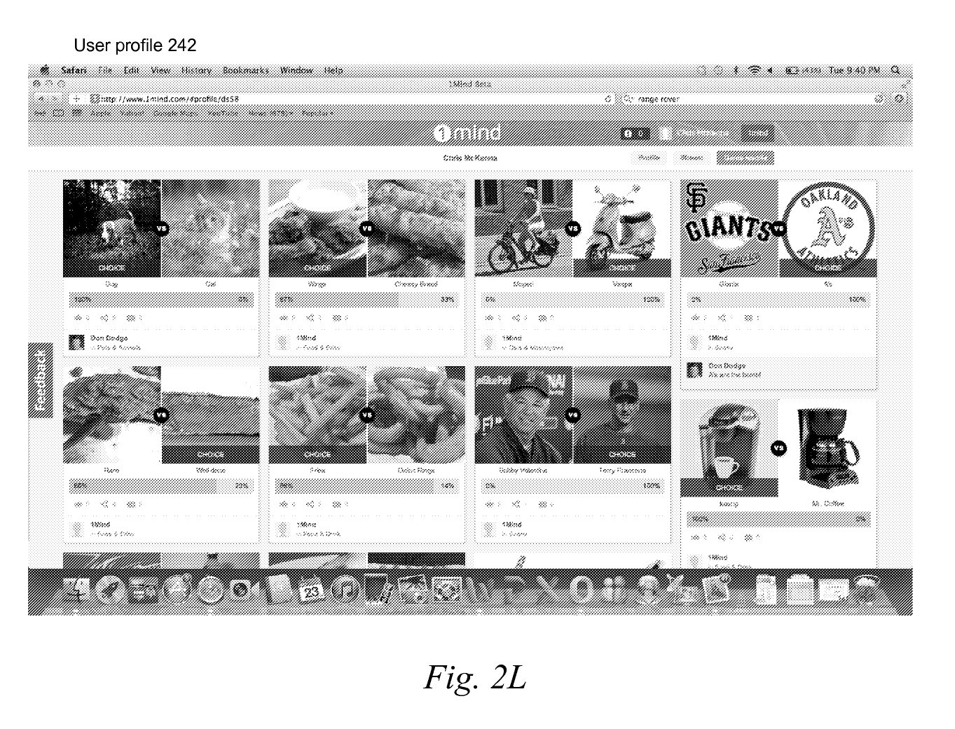

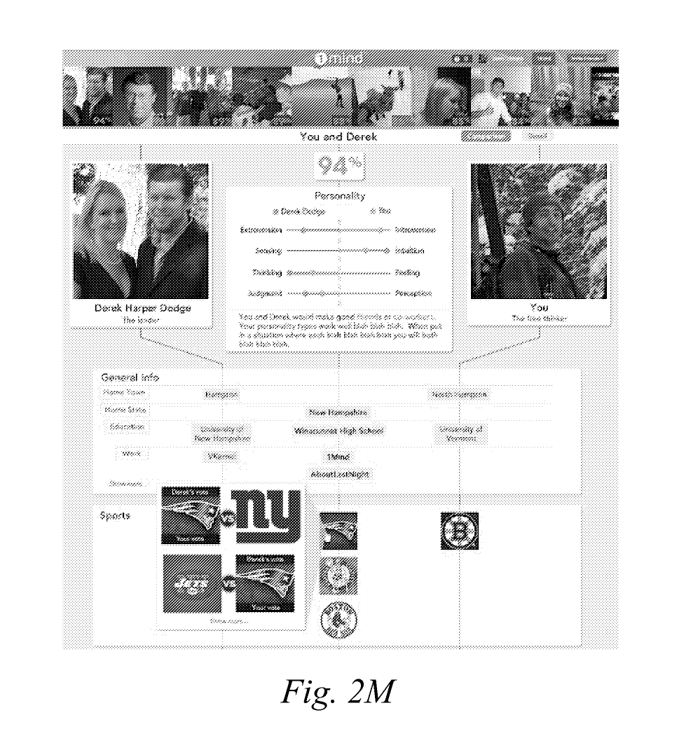

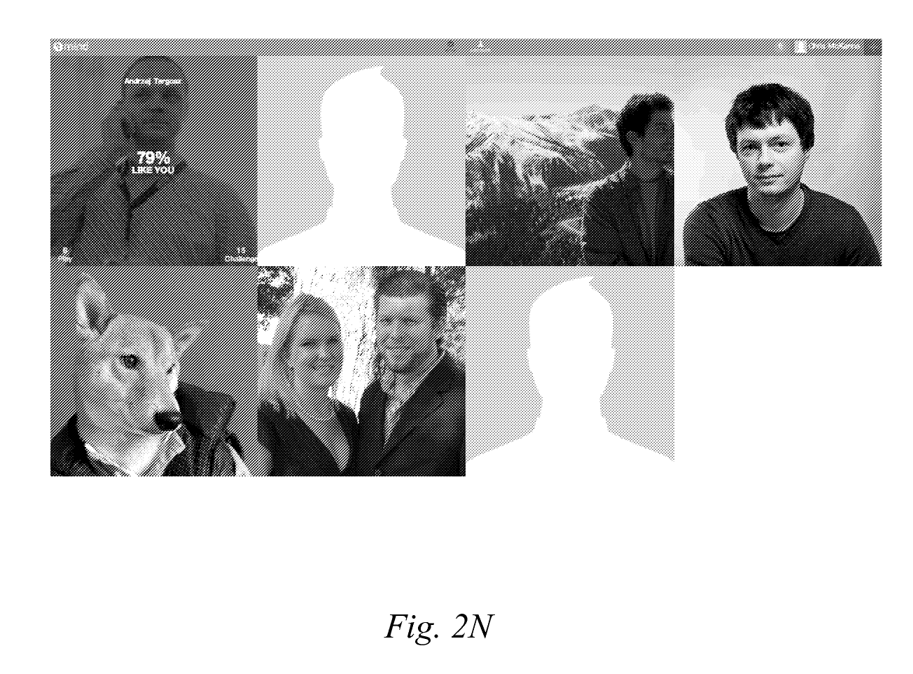

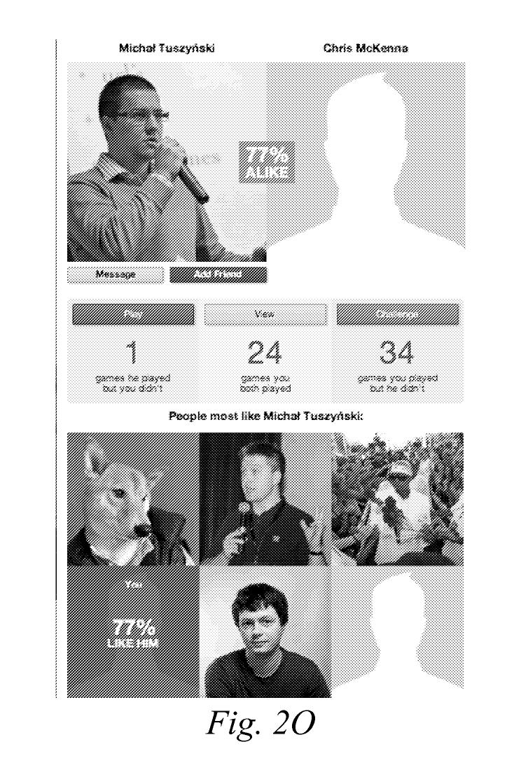

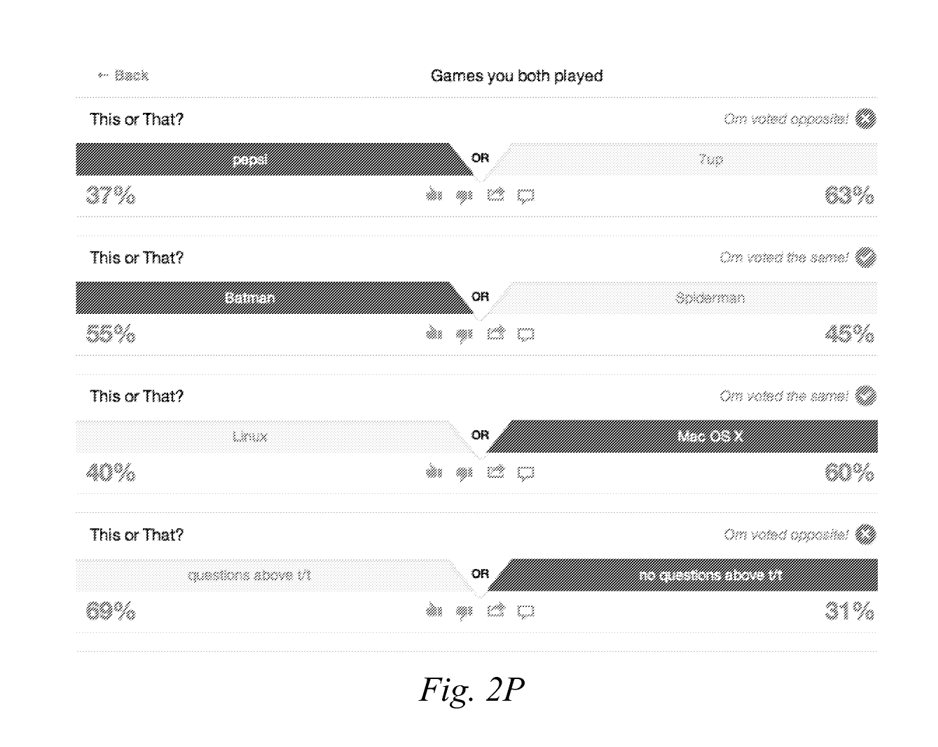

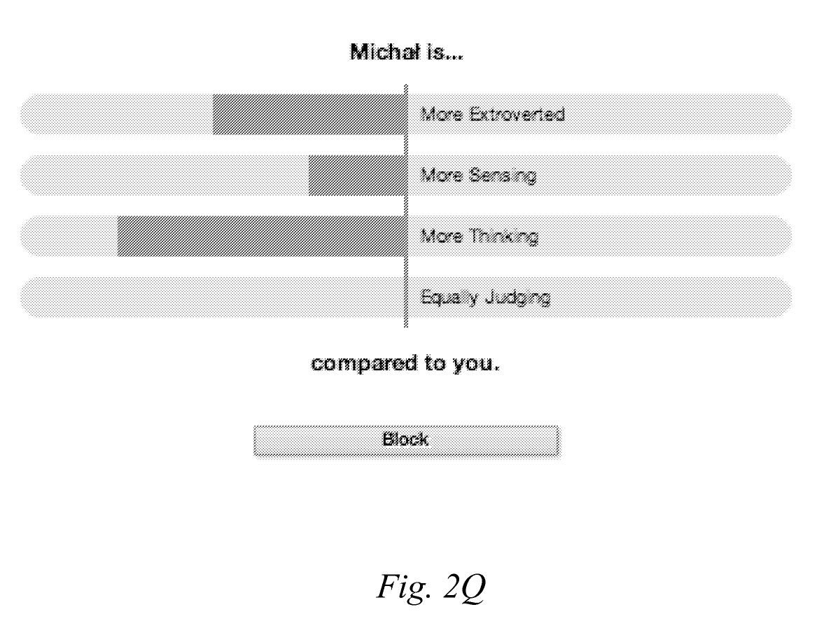

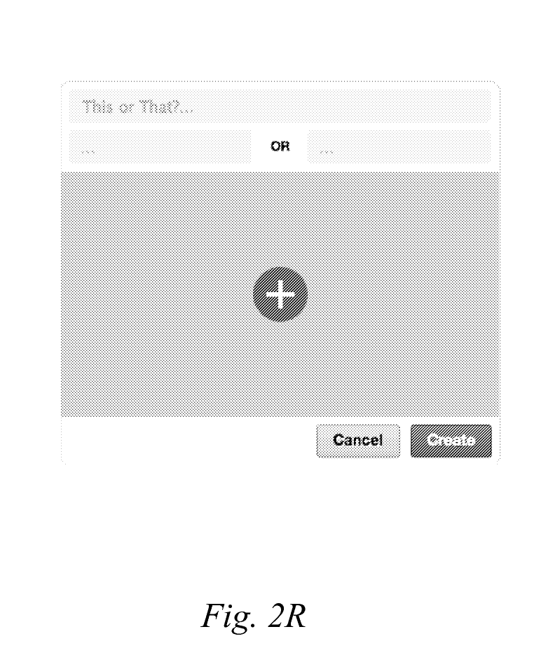

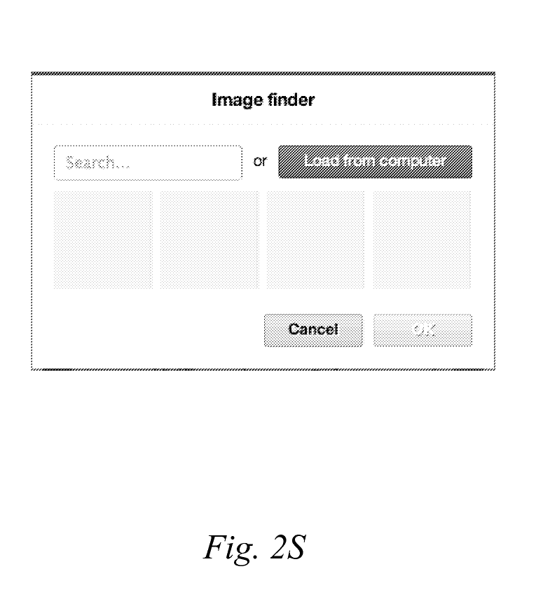

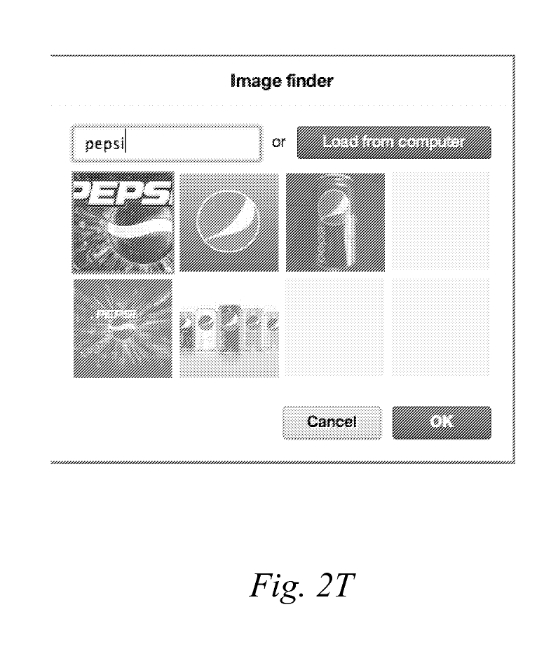

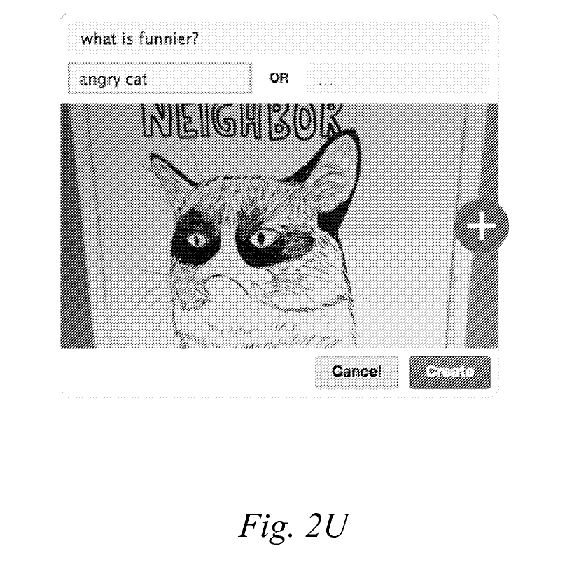

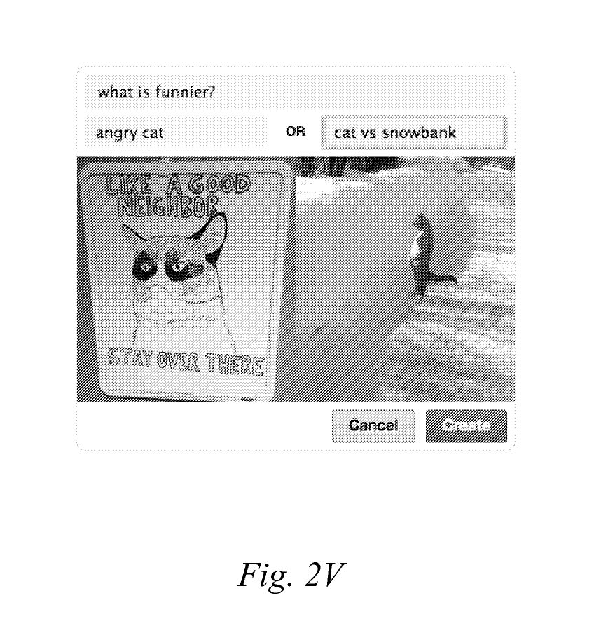

Referring to FIG. 2A, an embodiment of a system for a social discovery platform is depicted. In brief overview, a client 102 is in communication via a network 104 with one or more servers 106 operating the social discovery platform 120. The client 102 may include an application 202, such as web interface or mobile device application, to interface and interact with the social discovery platform 120 and the various components thereof. The social discovery platform 120 may include a likeness engine 220 that includes an interest graph generator 227 that generates an interest graph 243 from a plurality of different dimensions or inputs about a user's interest or likeness from a combination of one or more of results a personality test 210, category subscription 212 and game play 214, such as “This or That” games 215. The likeness engine applies a likeness algorithm 225 to each user's interest graph 243 to determine the likeness between each user and each other user. The likeness engine 220 may order or rank a list of users of the platform in terms of relative likeness or level of likeness to a particular user 230. The likeness engine 220 may provide a visual comparison of User A to User B. This comparison may include a visual representation of likeness scale based on personality traits. This comparison may include common attributes like home town, school, work, or other elements of a social profile. This comparison may include game results where both users made the same choices. A user may discover via this list 230 people that are likeminded and use social management functions 232 to connect, share and socialize with such likeminded people. The social discovery platform may store data to a data store 240, such as data about a user to a user profile 242 and interest graph 243. The likeness engine 220 may store data to the data store 240 regarding level of likeness between users.

Via the social discovery platform, users may generate content (e.g., user generated content) such as games, photos, listing and postings. Users may express their interests or preferences in the user generated content. The likeness engine may use the interest or expressed preferences in the user generated content to determine level of likeness between people. The interests in and likeness determinations with respect to the user generated content may also be stored in the data store. An analytics engine 245 may analyze the data stored in the data store 240 by the social discovery platform to provide metrics and other analytical information about users and use of the social discovery platform. A campaign engine 250 may provide an interface to configure and execute advertisement campaigns on the social discovery platform, or on other advertising networks, and may deliver social media advertisements to users of the social discovery platform, or through another advertising network on other web sites and platforms 251.

The social discovery platform may be in communication via one or more networks 104 with a 3^{rd} party platform 251 that provides any type and form of advertisements services or products, such as an ad server, advertisement network or ad delivery engine. In some embodiments, the campaign engine 250 may be designed and constructed to provide an interface to an ad server. In some embodiments, the campaign engine 250 may be designed and constructed to act as or provide the functionality of an ad server. In some embodiments, the campaign engine 250 may be designed and constructed to provide an interface to an advertisement network. In some embodiments, the campaign engine 250 may be designed and constructed to act or provide the functionality of an advertisement network. In some embodiments, the campaign engine 250 may be designed and constructed to provide an interface or otherwise act as a third-party or fourth-party data source for targeting advertisements by other platform 251 or otherwise for advertisement purposes.

The campaign engine may be designed and constructed to provide an interface by which other systems or platforms 251 may query and/or obtain a social graph and/or interest graph of one or more users of the social discovery platform. The campaign engine may be designed and constructed to create, maintain, track and manage a social graph, such as based on any data and information tracked by the social discovery platform. In some aspects, the social graph is a sociogram or a graph that depicts personal relations of users. The campaign engine may be designed and constructed to create, maintain, track and manage an interest graph, such as based on any data and information tracked by the social discovery platform.

In further detail, the application 202 may comprise any type and form of user interface for interacting and communicating with the social discovery platform 120. The application may comprise a web browser receiving and displaying web pages and content from the social discovery platform. The application may comprise any type and form of client agent executing on the device of the client and designed and constructed to interface to the social discovery platform. The application may comprise any type and form of mobile application, generally referred to as a mobile app, such as an application executing on a smart phone and designed and constructed to implement functionality of the social discovery platform and/or otherwise interact with the social discovery platform system.

The social discovery platform may use a plurality of different dimensions about a user to determine their interest and likeness with other users of the platform. The social discovery platform may identify and determine attributes about the user from profiles from other social networking sites, such as Facebook and Linkedln. For example, a user may log into or register with the social discover platform using a login from another social networking site, such as Facebook. From other social networking sites, the social discovery platform may identify information, such as place of birth, schools, places of employments, current and former residences, etc. The social discovery platform may obtain any interest graphs from such social networking sites. The social discovery platform may use the above information from these social networking sites as inputs to and/or dimensions to use by the likeness engine.

The social discovery platform may include and/or use a personality test 210 for one or more interest or likeness dimensions of a user. The social discovery platform, such as via application 220, may be designed and constructed to provide one or more personality tests, receive user input on such tests and/or evaluate and provide the results from such tests. The personality test may comprise any type and form of survey, questionnaire or test that evaluates and identifies a personality type, preferences, or traits. The personality test may be a questionnaire or other standardized instrument designed to reveal aspects of an individual's character or psychological makeup. The personality test may include any personality test based on the Myers Briggs Type Indicator (MBTI), the MMPI (Minnesota Multiphasic Personality Inventory), the Five Factor Model of personality, and/or based on any other personality type test which may be developed. The personality test may be a self-reporting inventory test also referred to as objective personality test. Such personality tests may involve the administration of questions, or items, to test-takers who respond by rating the degree to which each item reflects their behavior, and can be scored objectively. The term item is used because many test questions are not actually questions; they are typically statements on questionnaires that allow respondents to indicate level of agreement, such as a Likert-type scale. The user interface for the personality test may be designed and constructed for the user to quickly or easily identify a degree or level of agreement, such as via a sliding scale. The social discovery platform may store information on when the test was taken, the type of test, the number of times testes, and the results of such personality tests to the data store 240, such as in a user profile.

The social discovery platform may include and/or use a category selection or subscription 212 for one or more interest or likeness dimensions of a user. The social discovery platform may provide a set of graphical and/or textual elements in which each graphical and/or textual element represents a category of interest. For example, the social discovery platform may display a set or panel of pictures with each picture representing a category of interest. Text or a description of the category may accompany the picture. The user may be able to select the graphical and/or textual element for the category to express interest in that category or otherwise to subscribe to that category. The user may be able to select a plurality of different categories to express interest in each of the categories or otherwise to subscribe to those categories. A category may be referred to as a group and may be used to group content, such as games and user generated content. The categories of interest may include but is not limited to any of the categories identified in FIG. 2C.

The social discovery platform may include and/or use game(s) 214 for one or more interest or likeness dimensions of a user. In some aspects, the social discovery platform uses fun, casual and quick or easy to play games to learn about the interests and likes of a user. In this manner, the user may not realize they are expressing their interest or preference but instead enjoying the fun and interaction of the game. The games may be categorized or organized into groups based on categories. The games may be designed and constructed for a user to indicate a likeness or preference between two or more persons, places or things. For example, the game may provide a user interface for the user to select between two or more persons or two or more places or two or more things. The game may be what is referred to as a “This or That” game 215, in which a user selects between two or more choices. The games may be designed and constructed for a user to indicate a degree of likeness, preference, or interest in a person, place or thing. In some embodiments, the game may be a posting or a photo with one or more user interface elements for a user to express an interest, such as a like or dislike button. The game may include a share button for a user to share with other users or post to other social networking sites. The social discovery platform may display a stream of different games to the user responsive to completing one game. For example, if the user makes a selection for one “This or That” game, another “This or That” game is presented to the user that further refines that choice or preference with multiple levels of specificity. The social discovery platform may store the responses to and/or interactions with the games, including likes, sharing interactions, to the data store 240, such as to their user profile 242.

The social discovery platform may include a user generated content module 235 with an interface for users to generate content for the platform. The user generate content module may provide an interface for the user to identify, designated or categorize any user generated content into groups based on the categories. The user generated content module 235 may be designed and constructed to provide an interface through which a user may generate, design or configure their own game, such as their own “This or That” game. The user generated content module may be designed and constructed with an interface for a user to design or configure a list of items (such as photos or other media). The user generated content module may be designed and constructed with an interface for a user to create a posting, a listing or upload a photo. The social discovery platform may incorporate or integrate the user generated content into the category subscription and/or games and allow the user generated content to be input to the likeness engine and/or likeness algorithm. As users add more content to the platform the social media platform may change the level of likeness determined among the users.

The likeness engine 220 may be designed and constructed to process multiple dimensions of each of the users of the platform to determine a level of likeness 230 between users, such as via the interest graphs of the users. The likeness engine may comprise an application, program, library, service, process, task or any type and form of executable instructions executable on a device. The likeness engine may interface to the data store 240 to obtain any data about the interests or likes of a user, such as via the user profiles and/or interest graphs 243. The likeness engine may be designed and constructed to receive and process as input the results of the personality test 210, selection or subscription of categories 212 or responses and/or interactions to games 214. The likeness engine may be designed and constructed to receive and process as input any data from other social networks, such as inputs from Facebook, Linkedln, or other social networks, The likeness engine may receive and process these inputs from the social discovery platform's user interface and functional components used to implement the personality test 210, selection or subscription of categories 212 or responses and/or interactions to games 214. The likeness engine may receive, query or obtain these inputs from the data store, such as via the interest graph.

The interest graph generate 227 may comprise any type and form of executable instructions to generate, maintain, track and store structured data to provide or form an interest graph 243. The interest graph may comprise a graph or connectivity between a user and one or more interests or likeness based on any combination of personality test 210, selection or subscription of categories 212 or responses and/or interactions to games 214. In some embodiments, the user profile comprises the interest graph for the user. In some aspects, the interest graph 243 refers to the specific and varied interests that form one's personal identity, and connecting people based on those interests. On an individual scale, this may mean the different things one person is interested in—be it jogging, celebrity gossip, or animal rights—that make up their likes and dislikes, and what has more meaning to them over someone else. On a broader scale and in some aspects, the interest graph identifies the way those interests form unspoken relationships with others who share them, and expand to create a network of like-minded people. The interest graph generates such an interest graph based on user's interactions with the social discovery application, including preferences from “This or That” games, results of personality test and other functionality of the platform, such as category selections and user generated content, used to identify a person's preference, interest or likeness.

The interest graph 243 may comprise any type and form of data structures or objects to represent the various dimensions and inputs of likeness and interests of a user learned, received or identified via the social discovery application. Data structures or objects of the interest graph may represent and store data regarding the user's responses from game play indicating a preference. Data structures or objects of the interest graph may represent and store data regarding the user's results from one or more personality tests. Data structures or objects of the interest graph may represent and store data regarding the user's selection of categories of interest. Data structures or objects of the interest graph may represent and store data regarding the user's user generated games and content and categories of interest thereof. Data structures or objects of the interest graph may represent and store data regarding the user's interaction with other users via the social discovery application

The likeness engine 220 may include one or more likeness algorithms 225. The likeness algorithm 225 may comprise any type and form of algorithm, operation or function that takes as input one or more dimensions of one user and one or more dimensions of another user and produces as an output an indicator of degree or level of likeness between the two users, such as a percentage of likeness. To determine a level or degree of likeness 230 between one person and another person, the likeness algorithm, may use as inputs for any user any combination of the multiple dimensions of interest and likes from their interest graphs, such as but not limited to the personality test 210, selection or subscription of categories 212, responses and/or interactions to games 214, profile and/or interest graphs from other social networking sites (such as Facebook, Linkedln, or other social networks) and communities and/or data stored to the user profile. The likeness algorithm may apply different weights to each or two or more of the dimensions or inputs.

For each user, the likeness engine may apply the likeness algorithm to each of the other users in the platform. The likeness engine, via the likeness algorithm, may analyze and compare interest graphs of each user to each other user of the platform to determine similarities and differences between users. As such, the likeness engine may determine a level or degree of likeness 230 between each user and the each of the other users. The likeness engine may generate or produce an enumerated list of a level or degree of likeness between each user and other users, such as an ordered ranking of other users that are most like the user. The level of likeness may be expressed, represented or identifying using any type and form of scale or ranking. In some embodiments, the level of likeness may be a percentage of likeness, such as Bob is 75% like Jill. The ranking or level of likeness can use any numerical range or scale. The ranking or level of likeness can use any type and form of graphical indicators, such as an graphical element expressing someone is really like someone else. The ranking or level of likeness can use any type and form of text, string or description identifying or indicating a level of a plurality of levels of likeness between one user and another user. The social discovery platform may store the level of likeness between users in the platform to the data store, such as to the user profile and/or interest graph.

The likeness engine 220 may provide a visual comparison of User A to User B, such as by way of the example via the user interface embodiment of FIG. 2M, and the degree of likeness 230 between them. This comparison may include a visual representation of likeness scale based on personality traits. This comparison may include common attributes like home town, school, work, or other elements of a social profile. This comparison may include game results where both users made the same choices. The comparison may be based on a comparison by the likeness engine between interest graphs of users.

The social discovery platform may display a ranked list of the level of likeness and corresponding user profiles via any type and form of user interface, such as a dashboard or a user interface widget on a page of the user's account. The social discovery platform may display the profile, or portion thereof, such as a picture, with each ranked user and corresponding level of likeness. A user may discover via viewing and browsing of the list of people like them to determine whether or not they are interested in socially connecting with that user. A user may click on the profile of a user to learn more about their profile and the dimensions that influenced, impacted or otherwise produced their level of likeness. As such, the user can see what they have in common and what about the user makes them more or less like them.

A user may use any of the social management functions 232 to connect, share and socially interact and communicate electronically with another user. The social management functions 232 may comprise any type and form of user interface elements, widgets and functional components (e.g., executable instructions) to implement various functions such as requesting and accepting a connection between users or otherwise linking between users, sending and replying to messages between users, sharing or posting content among users, etc.

The social discovery platform, such as via the likeness engine 220, may generate, track and manage user profiles 242 for each of the users. The social discovery platform may store and manage the user profiles in the data store. The user profile may comprise contact information, educational history, work history, accomplishments, hobbies, affinities and interests. The user profile may comprise profile information from other social networking sites such as Facebook and Linkedin. The social discovery platform may store to a user's user profile and/or interest graph data about the user's personality test, the user's selection or subscription to categories and/or the user's interactions with and/or responses to games. The social discovery platform may store to a user's user profile and/or interest graph data about the user's user generate content 235. The social discovery platform may store to a user's user profile and/or interest graph data about the user's connections to other users. The social discovery platform may store to a user's user profile and/or interest graph data about the user's use of social management functions 232. The social discovery platform may store to a user's user profile and/or interest graph data about the user's client 102, such as type of application 202 and/or device, such as mobile device. Social discovery platform may store to a user's user profile and/or interest graph data about their preferences for certain products, services, brands, categories, posts, photos, listings, games and any other entity tracked by the platform.

The data store 240 may comprise an application, program, library, process, service, script, task or any type and form of executable instructions for tracking and managing information and data stored by, accessed by and/or used by the social discovery platform or any modules or components thereof. The data store may be a database. The database may be any type and form of Structured Query Language (SQL) database. The database may be any type and form of object oriented or object based database. The database may be any type and form of in-memory or real-time memory database. The database may comprise any type and form of graphical database. The database may comprise any type and form of data warehousing and/or analytical database. The database may comprise any type and form of multi-dimensional database. The database may store any data and information from any of the functions, operations, systems and methods described herein.

The analytics engine 245 may perform and provide results from any analysis on the data and information available via the social discovery platform, such as data stored in the data store. The analytics engine may comprise an application, program, library, process, service, script, task or any type and form of executable instructions. The analytics engine may be designed and constructed to perform analytics on data about a user interest graph, such as a user's personality, interests and likes based on a personality test, category of interest selection and subscription and game play stored in the interest graph. The analytics engine may aggregate data from user's profiles and/or interest graph. The analytics engine may compute or calculate metrics on data from user's profiles and/or interest graph.

The analytics engine may determine from the interest graphs and/or user profiles what dimensions are most common to a level of a likeness between users. The analytics engine may determine the interest graphs and/or user profiles what dimensions are most common among users most like each other or not like each other. The analytics engine may determine the interest graphs and/or user profiles any one or more dimensions of a user for targeting a campaign to the user.

The analytics may determine metrics on usage of the platform, such as determining a metric based on any one or more of the following: a number of users playing a game, numbers of users subscribing to a category, a number of users liking or sharing a photo, a number of users liking or sharing a list, a number of users showing a preference or interest in a brand, product or service, a number of users generating user generated content, number of added user generated content, number of views of a profile, number of users like other users within a certain threshold, number of users from same geography, same age or within certain age range, same school or work place.

The analytics engine may provide any type and form of user interface and/or application programming interface (API) to receive and respond to queries regarding data and metrics from the social discovery platform, such as querying the interest graphs of users. A user or another application, program or system may query the analytics engine to find any data, metrics and other information on the data. A user or another application, program or system may send a request to the analytics engine to query the data store based on query or search parameters. The analytics engine may generate and/or display any reports about any data or metrics about the data of the social discovery platform.

The campaign engine 250 may comprise an interface to configure and/or execute any type and form of campaign via the social discovery platform, or other advertising network. The campaign engine may comprise an application, program, library, process, service, script, task or any type and form of executable instructions. The campaign engine may be designed and constructed to execute advertisement campaigns to users of the social discovery application, or via other advertising networks. The campaign engine may be designed and constructed with an interface for a user or system, application or program to create, configure and initiate execution of a campaign. Based on user tracking information determined via the data store, such as stored interest graphs, the campaign engine may target campaigns to users based on their expressed interests and/or tracked interactions with the social discovery platform. The campaign engine may target campaigns to users based on analytics from the analytics engine, such as analytics applies to the interest graphs. The campaign engine may target campaigns to users based on their user profile, or other preferences and actions.

The campaign engine may target campaigns to users based on their interest graphs. The campaign engine may determine which user's interest graphs match, correspond or meet a predetermined threshold of matching criteria or target attributes of a campaign or a request for a campaign. User interactions or responses to such campaigns may be tracked and stores in the user's interest graph.

The campaign engine may generate, produce, deliver or display campaigns in the form of games. For example, a campaign may include a “This or That” game based on products or services of a brand, manufacturer or company. The campaign engine may generate, produce, deliver or display social media advertisements. Users may interact with the social media advertisements while the platform tracks and stores these interactions. The campaign engine may generate, produce, deliver or display campaigns in form of user generated content. The campaign engine may generate, produce, deliver or display campaigns in the form of display, banner or search advertisements. The campaign engine may generate, produce, deliver or display campaigns on one or more pages of a user's account with the social discovery platform. The campaign engine may generate, produce, deliver or display campaigns in one or more categories of interest to a user. The campaign engine may generate, produce, deliver or display campaigns in the stream of games or content that may be displayed to the user.

Referring now to FIGS. 2B-2U are embodiments of various user interfaces corresponding to the functionality of the social discovery platform. FIG. 2B illustrates an embodiment of results from a personality test 210 provided via the social discovery platform. In this embodiments, the personality test 210 comprises a “Myers-Briggs like” type of test. The user interface of the social media discovery platform identifies via a scale where the use falls with respect to standard personality type indicators. The user interface also provides a description of the results of the personality test.

Referring now to FIG. 2C, an example embodiment of a list of categories or groups the user may subscribe to are illustrated. The social discovery platform may provide a predetermined list of categories. The social discovery platform may provide an interface for a user to add, remove or edit any of the categories. The social discovery platform may allow users to create categories via user generated content.

FIG. 2D illustrates an embodiment of games 215 that may be played via the social discovery platform in order to receive input on user's interests or preferences via fun, casual game play. The user interface of the social discovery platform may provide a panel, list or stream of games for a user to play. The social discovery platform may provide to a user a series or group of one or more “This or That” games 214. In connection with the game play, the social discovery platform may display level of likeness scores or ranked listing between the user and other users, which may be dynamically updated or changed responsive to the game play.

Referring now to FIGS. 2E-2G, embodiments of user interfaces for generating user generated content are depicted. FIG. 2E illustrates an embodiment of a user interface for generating a “This or That” game. Via the user interface, the user may load images for “This or That” comparison while also identifying a title and/or URL. The user may also search for content images on the web, or “drag and drop” existing images from other games in the stream. The user may specify a category or group name to which to post or associate the game with. FIG. 2F illustrates an embodiment of a user interface for creating a photo listing or post in the social discovery platform. Via the user interface, the user may load an image for the photo or identify a URL to the image. The user may specify a category or group name to which to post or associate the photo with. FIG. 2G illustrates an embodiment of a user interface for creating a list of items in the social discovery platform. Via the user interface, the user may provide a title of the list and a title for each of the items in the list. The user may specify for each item in the list a picture or other description. The user may also be able to move items up and down the list while removing items. The user may specify a category or group name to which to post or associate the list with.

FIG. 2H illustrates an embodiment of a panel of user generated content in the form of lists. These lists may be filtered by groups. A user may like the list, share the list or add a comment to the list. In connection with the lists, the social discovery platform may display level of likeness scores or ranked listing between the user and other users, which may be dynamically updated or changed responsive to the user's interactions with the lists.

FIG. 2I illustrates an embodiment of a panel of user generated content in the form of photos. These photos may be filtered by groups. A user may like the photo, share the photo or add a comment to the photo. In connection with the photos, the social discovery platform may display level of likeness scores or ranked listing between the user and other users, which may be dynamically updated or changed responsive to the user's interactions with the photos.

FIG. 2J illustrates an embodiment of the social discovery platform providing an enumerated list of users ranked by level of likeness relative to a user. The enumerated list of users may identify the name of the user, a profile picture of the user and the scored level of likeness between the identified user and the specific user who is viewing the profiles. The enumerated list of users may use a graphical element, such as filled in scale to identify how much like the specific user. The user may select any of these other users from the profiles to get information on their personality test results as well as any other dimensions that may make them more or less like each other. The user may browse any of the users in the list and then use social management functions to connect with or communicate with such users.

FIG. 2K illustrates an embodiment of a user profile. The user profile may identify age, relations, location, education and work related information. The user profile may track and identify the results of the personality test. The user profile may identify and track the categories to which the user is subscribed. The user profile may identify and track likes and other interests identified or obtained via other social networking sites such as Facebook. FIG. 2L illustrates further information available via the user profile. The user profile may identify and track the user's game results, such as which item they selected in “This or That” games.

FIG. 2M illustrates an embodiment of profile comparison of two specific users. The likeness engine 220 may provide a user interface as illustrated in FIG. 2M that displays visual comparison of one user to another user and the degree of likeness 230 between them. The visual representation may include a side by side comparison of portions of the user's respective user profiles. The visual representation may identify and display the degree of likeness and identify those elements visually or graphically that support the degree of likeness. This comparison may include a visual representation of differences and similarities between the users relative to their respective personality traits. This comparison may include identifying and highlighting via graphical elements any common attributes like home town, school, work, or other elements of a user profile. This comparison may include identifying and highlighting via graphical elements any common preferences or expressed interests. This comparison may include game results where both users made the same choices. This comparison may include common or differing preferences for subject matter identified via the system, such as via game play or interaction with user generated content.

FIG. 2N illustrates an embodiment of a panel showing an enumerated list of users who are most like a user, such as by the user selecting a discover button or requesting to discover such users. The panel may display a set of tiles representation of each other user. Each tile may have a photograph, avatar or other visual identifier for the user. As a user mousse over or touches any of these tiles, the social discovery application may display a degree of likeness, such as a percentage, the number of the same games the users have played and/or the number of games that the user has challenged the identified user. A user can select any of the tiles to explore the profile of the user and see any comparisons to the user.

FIG. 2O illustrates an embodiment of a user interface that displays comparison information between users. The user interface may identify and display statistics related to games in connection and between the users. For example, the user interface may show the number of games both users played. By clicking on this information, another user interface may display the games responses and show a comparison of the similarities and/or differences. In another example, the user interface may show games that the user has not players. In a further example, the user interface may show games for which the user may request the other user to challenge. The user interface may also show others users who are like the selected user or the currently shown user profile.

FIG. 2P illustrates an embodiment of a user interface showing a comparison of the games responses from games that both users have players. The user interface may identify the game and the response of each user for the game and whether the response was the same or different.

FIG. 2Q illustrates an embodiment of a user interface that provides a comparison of personality traits between two users. For example, the user interface may display whether or not one user has more or less of a personality trait than another user. In another example, the user interface may display whether or not one user is has the same personality trait of another user. s

FIGS. 2R-2V illustrate another embodiment of user interfaces for user generated content for generating a game, such as a “This or That” game. FIG. 2R illustrates an embodiment of a user interface for starting the process of creating a user generated game. For example, by selecting the plus sign the user interface may provide additional screens or user interfaces in the process for creating a game, such as the user interface of FIG. 2S, which illustrates a user interface in which a user can select or load an image from a computing device or search for images via a search engine.

FIG. 2T illustrates an embodiment of a user interface identifying images available from a search of a keyword that a user has entered. As the user enters the keyword or search term, the user interface may display a list of images returned from a search via a search engine. The user may browse through and select one image from the set of resulting images to use for the game.

FIG. 2U illustrates an example of the user interface after a user has selected one image for one item or side of a “This or That” game. By selecting the plus sign, the user may create a second item or image, or otherwise another item for comparison for the “This or That” game. Responsive to selecting the plus sign, the system may display to the user the user interface of FIG. 2T for the user to provide or select an image. FIG. 2V illustrates an embodiment of a user interface after the user has selected or provide a second image or an image for the comparative or second item of the “This or That” game. By selecting the create button, the system will create the game in the system based on the current configuration of the game by the user. The social discovery application makes this game available for users to play.

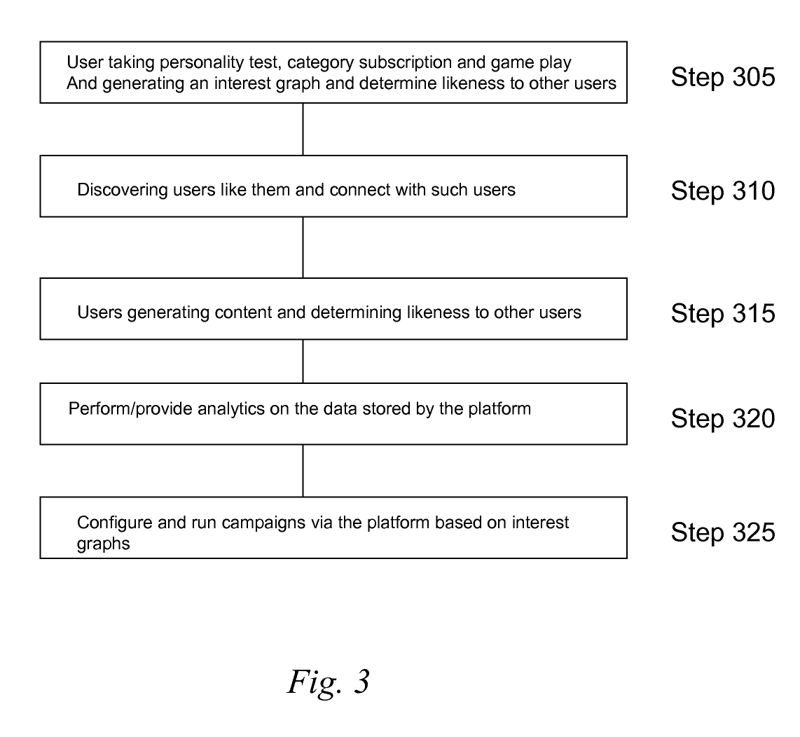

Referring now to FIG. 3, an embodiment of a method for using the social discovery platform is depicted. In brief overview, at step 305, users interacts with the platform by taking personality test, subscribing to categories and playing games and the platform determines level of likeness between the user and other users. At step 310, the user may browse a ranked list of users most like them and connect with them via the platform. At step 315, users may add content to the platform to provide further input into the likeness determinations and rankings. At step 320, the platform may provide analytics on any of the data stored or tracked by the platform. At step 325, the platform may run any campaigns, such as social media ads, via the platform.

In further detail, at step 305, a user may register and login to the social discovery platform such as using a Facebook account or via a registration and login interface of the social discovery platform. The social discovery platform may obtain profile and other data, such as likes and interests, from the user's other social networking sites, such as Facebook. The social discovery platform may prompt the user to take a personality test. The user may take the personality test and the social discovery platform may evaluate the test and provide test results. The social discovery platform may store the personality test results to the user's user profile. The social discovery platform may prompt the user to subscribe or select from a plurality of categories, such as by selecting graphical or visual elements representing each category from a panel of categories. The user may select or subscribe to one or more categories and the social discovery platform may store and track the selection via the user's user profile. The social discovery platform may prompt the user to play with one or more games, such as by displaying a plurality of “This or That” games. The user may play the games and the social discovery platform may store and track the game results to the user's user profile. Based on any combination of the user's personality test results, category subscriptions, game results and/or profile information, such as from Facebook, the social discovery platform may determine a level of likeness between this user and other users on the platform. The social discovery platform may display to the user an enumerated list of users ranked by relative likeness to the user.

The social discovery application may store to storage, such as a database or user profile, for each of a plurality of users of the platform information on their game play, such as responses, results of their personality test and/or selection of categories of interest. The social discovery application may store to the storage responses received during game play from the users playing one or more games provided by the social discovery application. The one or more games, such as “This or That” games are configured to receive a response from a user indicating a preference between two or more items during game play. The social discovery application may store to the storage results of each user's personality test and their personality profile. The social discovery application may store to storage any indicators of, such as via games, or selection of categories of interest or likeness of each of the users. As such, the storage may comprise for all users of the system any combination of games responses, personality test results and/or categories of interest. The likeness engine may determine a degree of likeness between each user and each of the other users based on one or more of, and or any combination of games responses, personality test results and/or categories of interest.

At step 310, the user may browse the enumerated list of users who are most like them to discover users who they may be interested in connecting or communicating with. The social discovery application may provide for each of the other users in the enumerated list the degree of likeness as a percentage identifying how much each of the other users is like the user. the social discovery application receiving a selection, by a user, from the enumerated list another user to discover items of likeness in the degree of likeness, the social discovery application, responsive to the selection, providing details on the degree of likeness between the user and the another user. The user may select the profile of any user in the list of users ranked as most like them. The user may view which dimensions of the user's profile provide the level of likeness between the users. The user may use any of the social management functions 232 to connect or communicate with the user, such as via sending a request to connect or via sending a message.

To help discover other users from the enumerated list who is like a user, upon the user selecting a profile of another users, the social discovery application provides a comparison between the user and a second which includes similarities and\/or differences between their stored user profile, such as similarities and/or differences between responses from game play, results of their personality test and categories of interest. The social discovery application may provide a comparison that identifies and/or highlight those items between two users profiles that make the users like each other and/or different from each other.

The social discovery application may identify the responses to games that are the same or different between users. The social discovery application may identify which games both users played, which games one user played and the other user did not play, which games neither user played. The social discovery application may identify which personality traits between the users are the same or different. The social discovery application may identify between users a degree of similarities and/or differences of personality traits. The social discovery application may identify which categories of interest between the users are the same or different. The social discovery application may identify between users the same categories of interest or which categories that the other user does not have an interest.

At step 315, users of the platform may add user generated content in the form of photos, lists and games. The platform provides interfaces for users to quickly add content to be published via categories and shared with others. As the content is added and published via the platform, users may interact with such content via playing user generated “This or That” games and liking and sharing user generated lists and photos. These users' interactions, such as game results, are stored, tracked and fed into the likeness engine of the platform which dynamically determines level of likeness between each user in the platform and other users of the platform.

At step 320, the platform provides analytics on any of the data stored and tracked by the platform. The analytics engine may aggregate any data across users, such as game results across users for each game. The analytics engine may perform any metrics on the data, such as number of users subscribing to a category or playing a game or showing an interest or preference for a brand, product or service. The analytics engine may receive a request for data or metrics from a user or application, program or system, or external advertising network, and respond with the requested data or metrics. The analytics engine may generate and provide reports on usage of the platform, usage by a user, profile of a user or any other data or metrics tracked by the platform.

At step 325, the platform may run any type and form of campaigns to one or more users of the platform. A user or application, program or system may configure a campaign via the campaign engine of the platform and request execution of the campaign via the platform, or via an external advertising network or system. The campaign engine may target campaigns to users based on user profiles or preferences of the user tracked via the user profile. The campaign engine may run a social media advertisement to users by presenting a game, such as a “This or That” game, designed and constructed for purpose of the campaign, such as to show a brand, product or service of the entity requesting the campaign. The campaign engine may run any type of advertisement campaign, such as display or banner advertisements to users of the platform. The social discovery platform, such as via the campaign engine, may store and track results of the campaign, such as user's interactions with the social media advertisement, for example their selection via a “This or That” game.

While the invention has been particularly shown and described with reference to specific embodiments, it should be understood by those skilled in the art that various changes in form and detail may be made therein without departing from the spirit and scope of the invention described in this disclosure.

What is claimed:

1. A method for generating an interest graph for a user based on game play, the method comprising:
(a) providing, by a social discovery application executing on a device, a plurality of games, each game of the plurality of games configured to receive a response from a user indicating a preference between two or more items during game play;
(b) receiving, by the social discovery application, responses from user from playing the plurality of games; and
(c) generating, by the social discovery application, an interest graph for the user based on responses received from the user from playing the one or more games.

2. The method of claim 1, wherein step (a) further comprising providing, by the social discovery application, a personality test to the user.

3. The method of claim 2, wherein step (c) further comprises generating, by the social discovery application, the interest graph for the user based on results of the personality test and the responses received from the user from playing the one or more games.

4. The method of claim 1, wherein step (a) further comprises providing, by the social discovery application, a list of categories for the user to select one or more categories of interest.

5. The method of claim 4, wherein step (c) further comprises generating, by the social discovery application, the interest graph for the user based on the user's selection of one or more categories of interest and the responses received from the user from playing the one or more games.

6. The method of claim 1, further comprising determining, by the social discovery application, a degree of likeness between the user and a plurality of users of the social discovery application based on the interest graph of the user and the plurality of user's interest graphs.

7. The method of claim 1, further comprising providing, by the social discovery application, a comparison between the user and a second user based on one of similarities or differences between their respective interest graphs.

8. The method of claim 1, wherein step (a) further comprises receiving, by the social discovery application, as a game for the plurality of games content generated by the user for the game, the content comprising the two or more items for which users indicate their preference via responses during game play.

9. The method of claim 1, further comprising receiving, by the social discovery application, a request to run a campaign to one or more users of the plurality of users of the social discovery application based on the plurality of user's interest graphs.

10. The method of claim 8, further comprising selecting, by the social discovery application responsive to the request, a first user of the plurality of users to target the campaign based on the first user's interest graph matching one or more criteria for the campaign.

11. A method for identifying a degree of likeness between users based on game play, the method comprising:
(a) storing, by a social discovery application executing on a device, to an interest graph of each of a plurality of users responses received during game play from each user from playing one or more games provided by the social discovery application, the one or more games configured to receive a response from a user indicating a preference between two or more items during game play;
(b) determining, by the social discovery application, a degree of likeness between each user and each of the other users of the plurality of users based on each user's interest graph; and
(c) providing, by the social discovery application responsive to the determination, an enumerated list of each of the other users ranked by the degree of likeness to the user.

12. The method of claim 1, wherein step (a) further comprising storing, by the social discovery application, to the interest graph of each user results of a personality test taken by each user and provided by the social discovery application.

13. The method of claim 2, wherein step (b) further comprises determining, by the social discovery application, the degree of likeness between each user and each of the others based on each user's interest graph comprising responses from game play and results of the personality test.

14. The method of claim 1, wherein step (a) further comprises storing, by the social discovery application, for each user a selection of categories of interest.

15. The method of claim 4, wherein step (b) further comprises determining, by the social discovery application, the degree of likeness between each user and each of the others based on each user's interest graph comprising the responses from game play and the selection of categories of interest.

16. The method of claim 1, wherein step (c) further comprises providing, by the social discovery application, a comparison between the user and a second user comprising one of similarities or differences between the user's interest graph and the second user's interest graph.

17. The method of claim 1, wherein step (a) further comprises generating, by the social discovery application, the interest graph for each user based on responses from playing the plurality of games and results of a personality test provided by the social discovery application.

18. The method of claim 1, wherein step (a) further comprises receiving, by the social discovery application, as a game for the one or more games content generated by the user for the game, the content comprising the two or more items for which users indicate their preference via responses during game play.

19. The method of claim 1, wherein step (c) further comprises providing, by the social discovery application, for each of the other users in the enumerated list the degree of likeness as a percentage identifying how much each of the other users is like the user.

20. The method of claim 1, further comprising receiving, by the social discovery application a selection, by the user, from the enumerated list a second user to discover items of likeness in the degree of likeness, the social discovery application, responsive to the selection, providing details on the degree of likeness between the user and the second user.
